(19) United States
(12) Patent Application Publication
(10) Pub. No.: US 2015/0136898 A1
(43) Pub. Date: May 21, 2015

(54) Telescopic Wing and Rack System for Automotive Airplane

(71) Applicant: Jeremiah Benjamin Bowe McCoy, Los Angeles, CA (US)

(72) Inventor: Jeremiah Benjamin Bowe McCoy, Los Angeles, CA (US)

(21) Appl. No.: 14/525,167

(22) Filed: Oct. 27, 2014

Related U.S. Application Data
(60) Provisional application No. 61/961,934, filed on Oct. 28, 2013.
(60) Provisional application No. 61/961,935, filed on Oct. 28, 2013.

(51) Int. Cl. B64C 3/56; B64D 27/26

(52) U.S. Cl. CPC B64C 3/56; B64D 27/26
USPC 244/49

(57) ABSTRACT

The invention is a vehicle for personal transportation with the ability to convert between two alternate modes of transport, as an automobile for transportation on roads and as a personal aircraft for travel between municipal airports, utilizing retractable telescoping wings and a foldable frame.

### BACKGROUND OF THE INVENTION

The present invention is in the technical field of automobiles and personal aircraft. More particularly, the present invention is in the technical field of systems capable of converting between an automobile and an aircraft.

The idea of combining the capabilities of an automobile and an aircraft in a single vehicle is nearly as old as the original inventions themselves. There have been many inventors and patents over the years that have attempted to accomplish a successful union of the ability to drive and the ability to fly into a single vehicle, with very limited success. The primary problems leading to this difficulty come mostly from the fact that the two modes of operation have very different design requirements and the conversion between the two modes can be an awkward transition for the operator. Creating a design that can easily accommodate the spatial requirements and safety features of an automobile on the roads while allowing for an easy conversion to a vehicle that uses wings to achieve flight in the air is a difficult challenge. The following is a list of the most significant attempts to create such a union.

There are many other patents for allowing a vehicle that is capable of driving on roads to also be able to fly that have used a variety of mechanisms for folding or otherwise storing the wings, each with certain specific limitations that have caused them not to be adopted for commercial application. The present invention embodies the inventor's best effort to create a novel solution to overcome the limitations of previous inventions in the field.

### SUMMARY OF THE INVENTION

The present invention is an automotive aircraft enabled by a wing system consisting of a set of telescoping main wings and telescoping forward canards connected by a folding frame which can be attached via struts to a lightweight automobile or other drivable vehicle, allowing the vehicle to be flown in a manner common to small personal aircraft and driven on roads in a manner common to automobiles while offering a simple conversion between the two modes of operation. Using telescoping wings has the advantage of requiring very little storage volume compared to the volume of the wings in their fully deployed state, and protects the surfaces of the wings when stored for driving on the road. The wing system can also be removed from the vehicle when not needed.

The telescoping wings are made up of a plurality of individual nestling sections that can be extended to the full wingspan for flight and retracted to within the width of a street legal vehicle for driving. Two sets of wings are used in a canard configuration, consisting of large main wings mounted near the rear of the vehicle and smaller forward canard wings, which act as horizontal stabilizers. The main wings and forward canards each consist of multiple sections of nestling exterior panels supported by wing ribs and pairs of sliding, interlocking wing spars which, along with the exterior panels, provide the primary structural support for the wings. When extended, the main wings provide the majority of the lift needed for flight. The forward wings serve as horizontal stabilizers to control pitch and roll, and also contribute to the total lift. Vertical stabilizers to control yaw are mounted toward the rear of the craft at the ends of the main wings.

The main wings and forward canards are comprised of multiple telescoping sections that allow the span of the wing to be greatly reduced or expanded automatically. Each section of the wing is comprised of an exterior skin panel with an airfoil cross section, connected on the inboard edge to a wing rib. The wing rib is in turn connected to a pair of wing spar sections, one forward and one aft. Structural support across the wing spar is provided by the interlocking design of the wing spar sections, which overlap in such a way as to maintain rigidity as a beam while allowing the length to be extended and retracted, using simple beam elements with offset, overlapping flanges for the wing spar sections which nestle adjacent to one another in series.

In the design of the wing sections, the inward wing skin panels have a slightly greater cross sectional area than the outward sections, sequentially, allowing the outward sections to fit within the inward sections in series. The wing spar sections are longer than the wing skins, and connect to the wing spar sections of the adjacent wing sections with sufficient overlap to maintain structural integrity during flight. The wing ribs are constructed with a rectangular hole large enough to accommodate the entire wing spar assembly when collapsed, and each wing rib is directly fastened near the inward end to two wing spar sections for each of the sections in the wing. The wing rib on the inward edge of each wing section is also directly connected to the wing skin of the same section, and when extended, also supports the outward edge of the next adjacent wing skin in the inward direction so that both edges of the wing skin in each section are supported.

The wing spar sections together comprise the wing spar assembly which is extended and retracted to change the span of the wing. The wing spar sections are beams formed with a cross section similar to an I-beam, with flanges that are offset so that the wing spar sections can nestle against each other while the flanges overlap. The flanges are also formed with corresponding lips on each flange that serve to hook into the lips on adjacent spars and lock the adjacent sections together in the transverse axes while still allowing slip in the longitudinal axis of the beam. This design allows the spar assembly to be extended and retracted while maintaining internal structural support for the wing. When fully extended, stops on the top and bottom of each spar contact the wing rib of the next outward section to prevent the beams from extending beyond the minimum overlap needed to maintain a rigid structure. Actuated or spring loaded pins at the outward ends of each wing spar extend between the upper flanges of the wing spars and into holes in the lower flanges of the adjacent wing spars when extended to further reinforce the structure.

The extension and retraction of the wing can be accomplished by one of several automatic mechanisms. In the preferred embodiment, a motor fixed to one end of each wing spar drives gears which act upon teeth set into the flange of the adjacent wing spar, extending or retracting the assembly based on the direction of rotation. Another embodiment would use thin pneumatic or hydraulic cylinders connected to each end of each wing spar section to push apart or draw together the spars in the wing spar assembly. Still another embodiments would include the use of a pulley system, in which a band or cable runs back and forth around the outside of each wing spar between pulleys at either end, drawing the spar sections outward when the cord is pulled in by a winch or other mechanism.

The telescoping wings are mounted above the body of the vehicle to a wing rack system which is attached to the internal vehicle frame from above by support struts connected by couplings to the frame. The forward struts may disconnect from the couplings and the forward section of the wing rack may fold backward while the wings are retracted, allowing the entire device to reside above the roof of the vehicle while in configuration for driving on roads. The conversion may be achieved automatically. Also attached to the wing rack is a rear-mounted propeller, which is connected by a drive shaft and a coupling to the vehicle engine to provide the thrust needed for flight.

In converting to aircraft mode, two stages of conversion are accomplished separately. First, the wing rack system unfolds from the stored configuration. The forward section of the frame, which supports the canards (forward horizontal stabilizers) folds forward on hinges in the frame between the forward and main wings; and the two forward support struts fold downward to connect to the couplings in the forward section of the vehicle, connecting to the vehicle frame above the front wheels. In the second stage of conversion, the two sets of wings are extended telescopically from their collapsed configuration to create the lifting surfaces, which are the main wings mounted to the wing rack above the rear wheels behind the cabin, and the canards mounted to the wing rack forward of the cockpit above the front wheels.

To convert from aircraft to automobile mode the same process is completed in reverse. First, the main wings and the canards retract telescopically into their retracted configuration. Then, the couplings connecting the forward support struts to the vehicle release, and the forward section of the wing rack which is supporting the canards folds back into its stored position behind the passengers. The folding mechanism allows the entire rack assembly to be reduced to a size that is suitable to be mounted above the roof of an existing automobile without significantly affecting its performance. The vehicle can be driven on roads with the wing system folded and collapsed, or, by disconnecting all of the couplings connecting the wing system to the vehicle body, the entire device may be removed when not needed for flight and the vehicle can function solely as an automobile without carrying the wing system along with it.

The device is intended to be adapted to a typical sports-car type automobile with an aerodynamic body, a rectangular wheel pattern with wheels and suspension suitable for driving conditions, takeoff and landings, a passenger compartment and windshield, headlights and all required external lighting to drive legally on roads, although a three-wheeled or two wheeled variation would be possible. The vehicle should use a mid- or rear-mounted engine and transmission which provide power to propel the vehicle forward. The vehicle should also be lightweight, optimally less than 2000 lbs, and have an engine powerful enough to drive a propeller with sufficient thrust to achieve flight. Several existing models of this type of vehicle are suited for adaptation to accept this type of wing rack device.

The system allows the vehicle two primary uses, as an automobile for travel on surface roads and as an aircraft for travel between airports. In automobile configuration, it is operated in the same manner that the vehicle would ordinarily be with the usual controls for steering acceleration and braking. In aircraft configuration, the control system is reconfigured to be similar to the controls of conventional small aircraft. In both modes the operation of the vehicle is subject to the same regulations and procedures as common vehicles of either respective type. The vehicle has many possible applications such as personal travel or commuting by air and road, commercial air transportation or as an air taxi, law enforcement, or as a military aircraft.

### BRIEF DESCRIPTION OF THE DRAWINGS

FIG. 1 is a perspective view of the vehicle in aircraft configuration with the wings extended and wing rack frame fully deployed

FIG. 2 is a side view of the vehicle in aircraft configuration with the wings extended and the rack frame fully deployed

FIG. 3 is a perspective view of the vehicle in aircraft configuration with the wings extended and wing rack frame fully deployed. The exterior panels of the wings and the body have been removed to show the internal components of the wings and the vehicle.

FIG. 4 is a side view of the vehicle in aircraft configuration with the wings extended and wing rack frame fully deployed. The exterior panels of the wings and the body have been removed to show the internal components of the wings and the vehicle.

FIG. 5 is a perspective view of the vehicle with the wings retracted and the wing rack frame still unfolded, in the first stage of conversion between the aircraft and automobile configurations.

FIG. 6 is a side view of the vehicle with the wings retracted and the wing rack frame still unfolded, in the first stage of conversion between the aircraft and automobile configurations.

FIG. 7 is a perspective view of the vehicle with the wings retracted and the wing rack frame still unfolded, in the first stage of conversion between the aircraft and automobile configurations. The exterior panels of the wings and the body have been removed to show the internal components of the wings and the vehicle.

FIG. 8 is a perspective view of the vehicle in automobile configuration, with the wings retracted and the wing rack frame folded above the vehicle.

FIG. 9 is a side view of the vehicle in automobile configuration, with the wings retracted and the wing rack frame folded above the vehicle.

FIG. 10 is a perspective view of the wing rack system with the wings retracted and the wing rack frame folded up, removed from the vehicle.

FIG. 11 is a side view of the wing rack system with the wings retracted and the wing rack frame folded up, removed from the vehicle.

FIG. 12 is a perspective view of the wing rack system with the wings retracted and the wing rack frame folded up, removed from the vehicle. The exterior panels of the wings have been removed to show the internal components of the wings.

FIG. 13 is a perspective view of the wing rack frame unfolded with the wings removed to show only the frame

FIG. 14 is a perspective view of the wing rack frame folded with the wings removed to show only the frame.

FIG. 15 is a perspective view of the main wings in the extended configuration

FIG. 16 is a perspective view of the main wings in the extended configuration with the exterior wing skin panels removed to show the internal structure of the wing

FIG. 17 is a perspective view of the main wings in the retracted configuration

FIG. 18 is a perspective view of the main wings in the retracted configuration with the exterior wing skin panels removed to show the internal structure of the wing

FIG. 19 is a cross-sectional side view of the retracted main wing, showing the cross-section of the wing spars and how they connect to one another, the wing ribs, and the nestled wing skin panels.

FIG. 20 is a perspective view of the two inner-most wing sections with the wing skin panels removed, also showing the gear type extension and retraction mechanism

FIG. 21 is a perspective view of the two outer-most wing sections with the wing skin panels removed, also showing the gear type extension and retraction mechanism

FIG. 22 is a perspective view of the canard wings in the extended configuration

FIG. 23 is a perspective view of the canard wings in the extended configuration with the exterior wing skin panels removed to show the internal structure of the wing

FIG. 24 is a perspective view of the canard wings in the retracted configuration

FIG. 25 is a perspective view of the canard wings in the retracted configuration with the exterior wing skin panels removed to show the internal structure of the wing

FIG. 26 is a frontal view of one of the wing sections with the wing skin panels removed showing the gear type extension and retraction mechanism.

FIG. 27 is a sectional view from the frontal direction of one of the wing sections with the wing skin panels removes, showing the wing rib and the aft wing spar section with the gear type extension and retraction mechanism.

FIG. 28 is a perspective view of the two inner-most wing sections with the wing skin panels removed, showing the pneumatic type extension and retraction mechanism

FIG. 29 is a perspective view of the two outer-most wing sections with the wing skin panels removed, showing the pneumatic type extension and retraction mechanism

FIG. 30 is a frontal view of one of the wing sections with the wing skin panels removed showing the pneumatic type extension and retraction mechanism.

FIG. 31 is a perspective view of the two inner-most wing sections with the wing skin panels removed, showing the cable type extension and retraction mechanism

FIG. 32 is a perspective view of the two outer-most wing sections with the wing skin panels removed, showing the cable type extension and retraction mechanism

FIG. 33 is a frontal view of one of the wing sections with the wing skin panels removed showing the cable type extension and retraction mechanism.

### DETAILED DESCRIPTION OF THE INVENTION

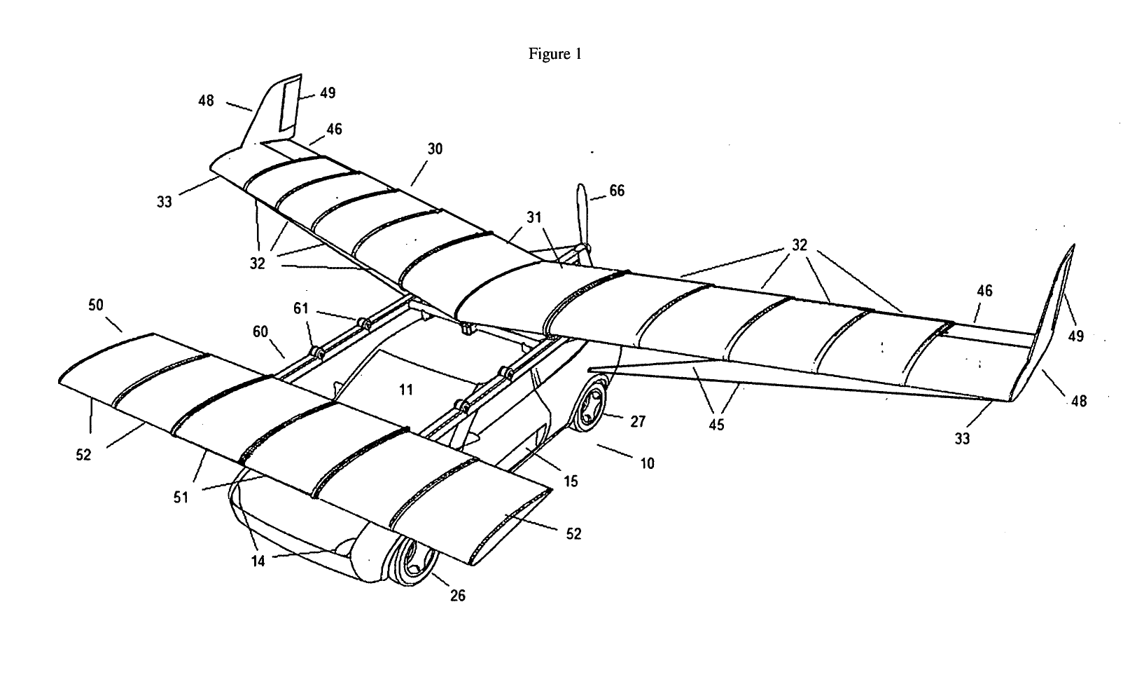

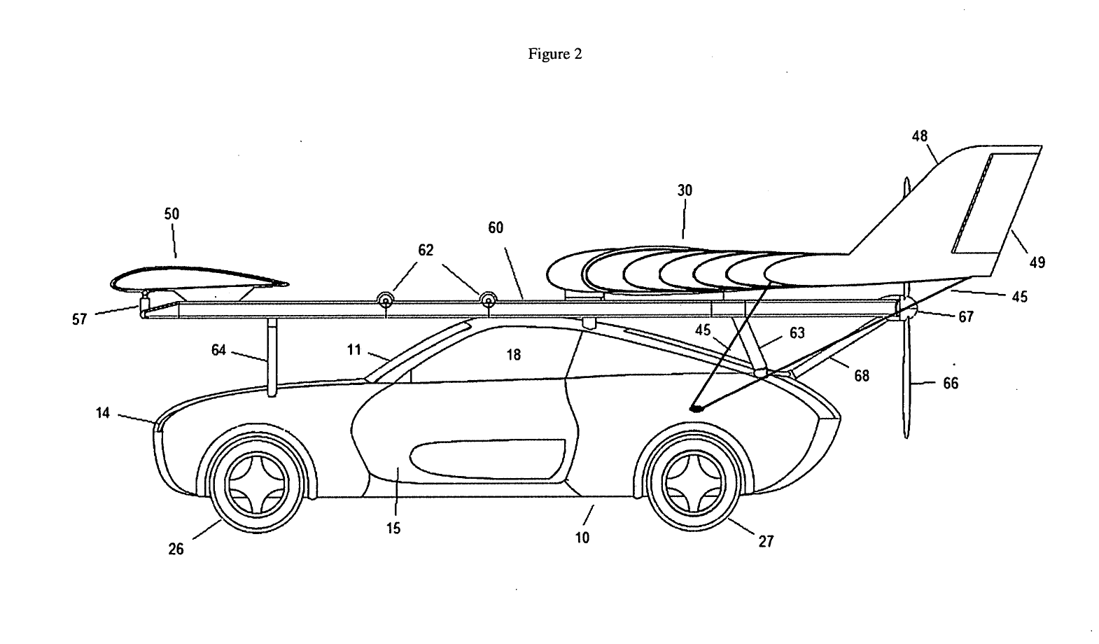

Referring now to the invention as shown in FIGS. 1 and 2 is an automotive aircraft with rear main wings 30 and forward canard wings 50 attached to a wing rack frame 60 in configuration for flight. The wing rack frame 60 is designed to support two sets of wings, the main wings 30, and forward canards 50 connecting them to the vehicle body 10. The wing rack frame 60 is attached to the vehicle body and held by support struts 63, 64. The vehicle body 10 is typical of an automobile with front and rear wheels 26, 27 arranged in a traditional wheel pattern, containing a passenger compartment with doors 15, windshield 11 and all the typical safety and operational mechanisms of an automobile.

Referring in more detail to the invention as shown in FIGS. 1 and 2, the main wings 30 extend from the wing rack frame 60 over the rear wheels 27 and the forward canards 50 extend from the wing rack frame 60 over the front wheels 26. The main wings 30 are comprised of individual sections 31, 32, 33 which connect to each other in series, and the forward canard wings 50 are likewise comprised of individual sections 51, 52 of a smaller number. While extended in flight configuration, the main wings 30 and forward canards 50 generate the lift necessary to counter the gravitational force on the vehicle and allow it to fly. The forward canards 50 are also divided in the middle allowing the left and right canards 50 to be individually adjusted to different angles of attack. This way the canards 50 provide control of pitch and roll, as well as contributing to the lift. Vertical stabilizers 48 extend from the ends of the main wings 30 to provide aerodynamic stability with rudder flaps 49 for yaw control. Ailerons 46 in the outermost wing sections 33 provide trim and roll control. Guy wires 45 connected to the outer ends of the main wings 30 provide additional support for the vertical forces of lift on the main wings 30. A propeller 66 mounted to the wing rack frame 60 at the rear of the vehicle propels the vehicle forward in flight.

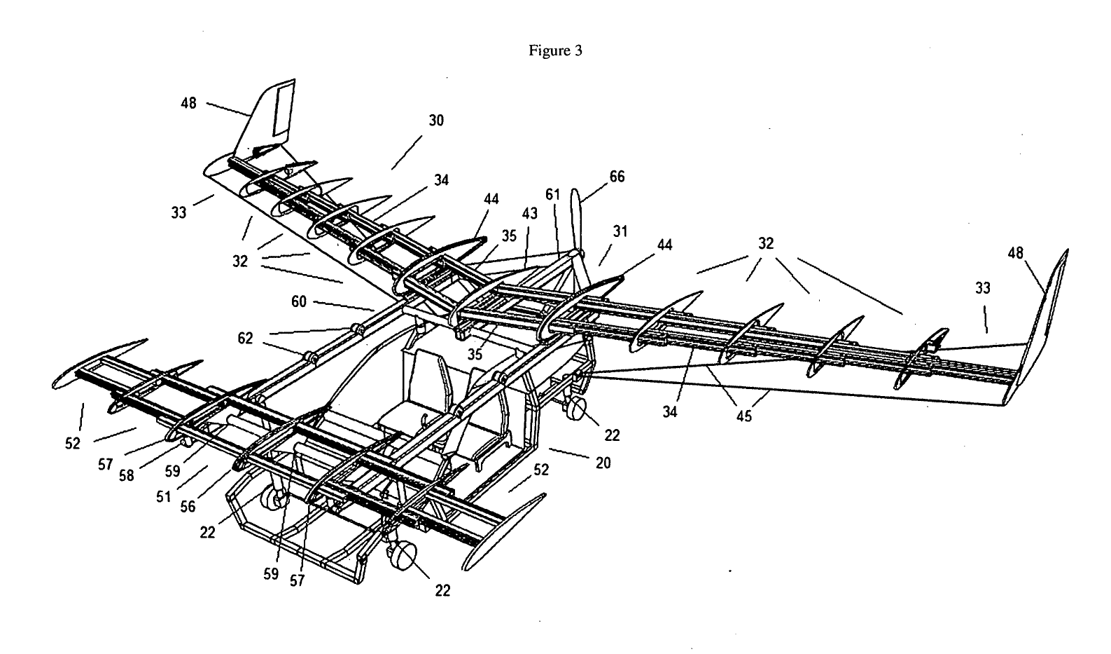

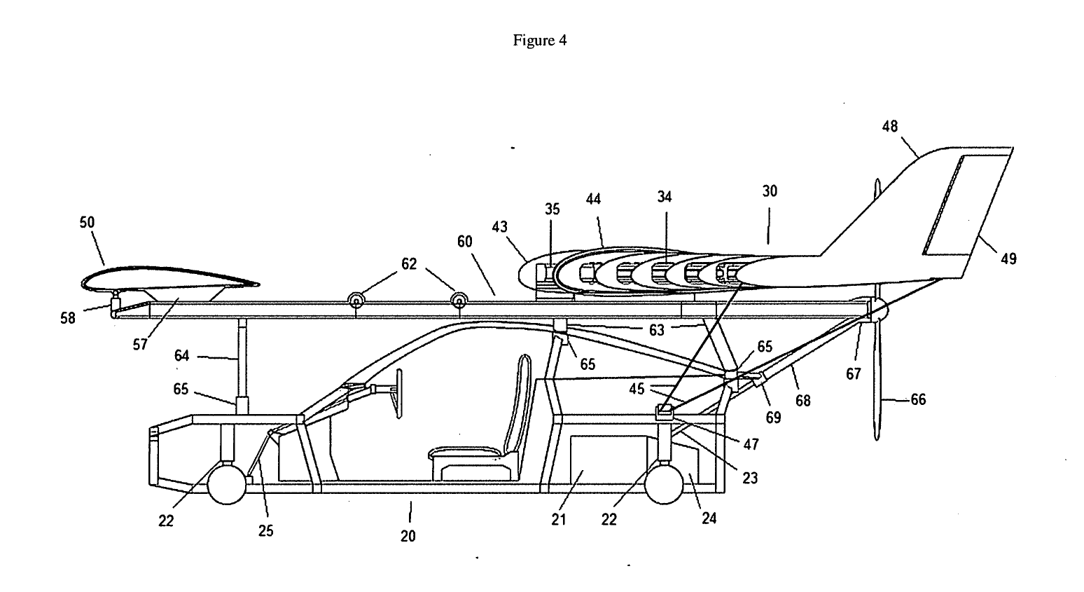

Referring to the invention as shown in FIGS. 3 and 4, the internal structure and components of the vehicle and the wings in their extended configuration provide the structural support necessary for flight. The vehicle body is 10 is supported by an internal frame 20 which provides a structure for the mounting of the internal components of the vehicle, including the engine 21, suspension 22, drive train 23, transmission 24, steering mechanism 25 and other components. In addition to the typical automotive features, the frame 20 has attached strut couplings 65 at the locations where the forward and rear frame support struts 64, 63 connect with the vehicle frame 20. The forward and rear frame support struts 64, 63 connect the vehicle frame 20 to the wing rack frame 60 above. The guy wires 45 that connect to the outer ends of the main wings 30 also connect to winches 47 attached to the vehicle frame 20 above the rear wheels 27 capable of supporting the loads applied by the guy wires 45 in flight.

Still refereeing to the invention as shown in FIGS. 3 and 4, the power for the wheels and the propeller are provided interchangeably by a single engine 21 with a transmission 24 capable of directing power to either the rear wheels 27 or to the propeller 66, depending what mode the vehicle is in. The power for the propeller 66 during flight is provided by the engine 21 through a drive shaft 68 connected to the transmission 24 and by shaft coupling 69 to the propeller hub 67. Separate outputs from the transmission 24 power the propeller 66 when in flight and provide power to the rear wheels 27 when driving on the ground.

Still referring to the invention as shown in FIGS. 3 and 4, the wing rack frame 60 provides a structure to which the main wings 30 are connected by a center wing support 43 and outer wing supports 44. The center wing support 43 is fastened to the central wing support beam 61, and provides the attachment point for the central wing spar sections 35 of the wing spar assembly 34 to connect to the wing rack frame 60. The wing spar assembly 34 provides an internal structure to support the main wings 30, by connecting the inner, intermediate and outer main wing sections 31, 32, 33 by a series of sliding wing spar sections 36 to the central wing spar sections 35 and thereby to the central wing support 43 and the central wing support beam 61 which is part of the wing rack frame 60. Thereby the outer aerodynamic surfaces of the wings are internally supported by the wing spar assembly 34 and connected by the center wing support 43 to the wing rack frame 60. The outer wing supports 44 also connect to the wing rack frame 60, and to the outer edges of the inner wing sections 31. When the main wings 30 are extended, the wing rib 38 of the first intermediate wing section 32 is positioned directly within the outer wing support bracket 43 and so carries some load from the wing spar assembly 34 to the wing rack frame 60. In addition, the outermost wing sections 33 of the main wings 30 house the ailerons 46 to control roll and trim, and horizontal stabilizers 48 at the end of the outermost wing sections 33 contain rudders 47 to control yaw. If split ailerons 46 on the upper and lower surface of the outermost wing section 33 are used, they may be flared in flight to provide aerodynamic braking for landing.

Referring again to the invention as shown in FIGS. 3 and 4, like the main wings 30, the forward canards 50 are comprised of inner and outer sections 51, 52 and attached to the wing rack frame 60 by inner and outer supports 56, 57. The inner and outer canard supports 56, 57 are mounted by canard pivots 59 to the wing rack frame 60. The canard pivots 59 allow the canard angle of attack to be adjusted independently by the extension or retraction of the canard actuators 58 which connect the forward portion of the outer canard supports 57 to the forward ends of the wing rack frame 60.

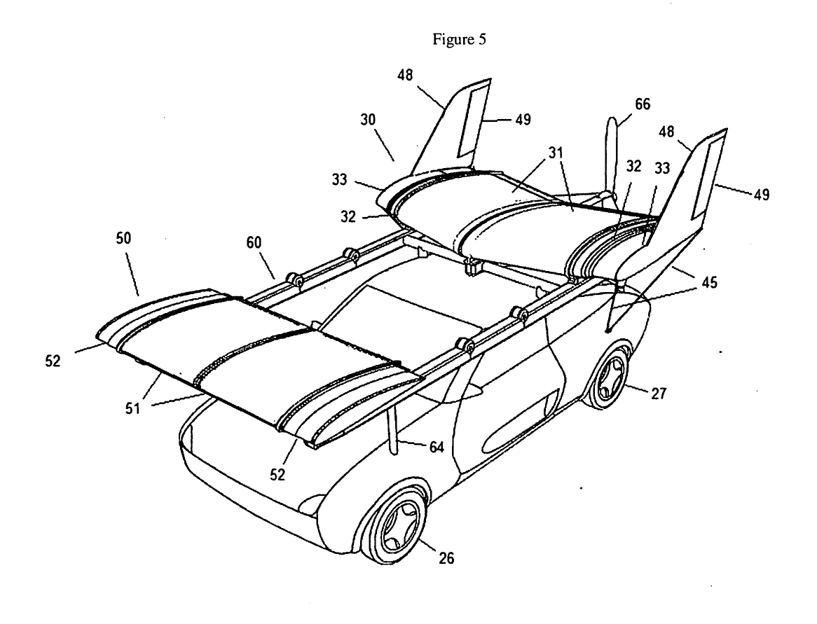

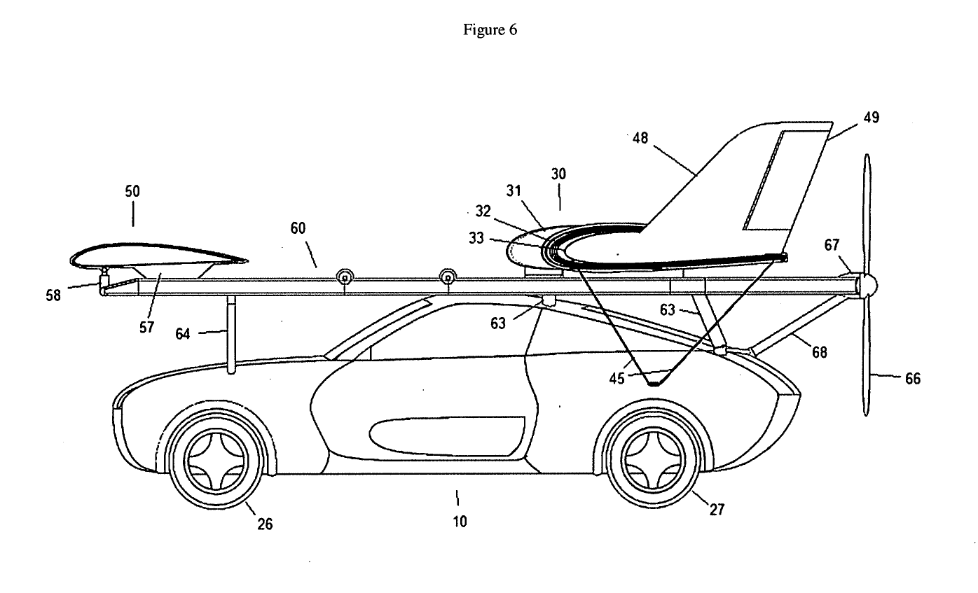

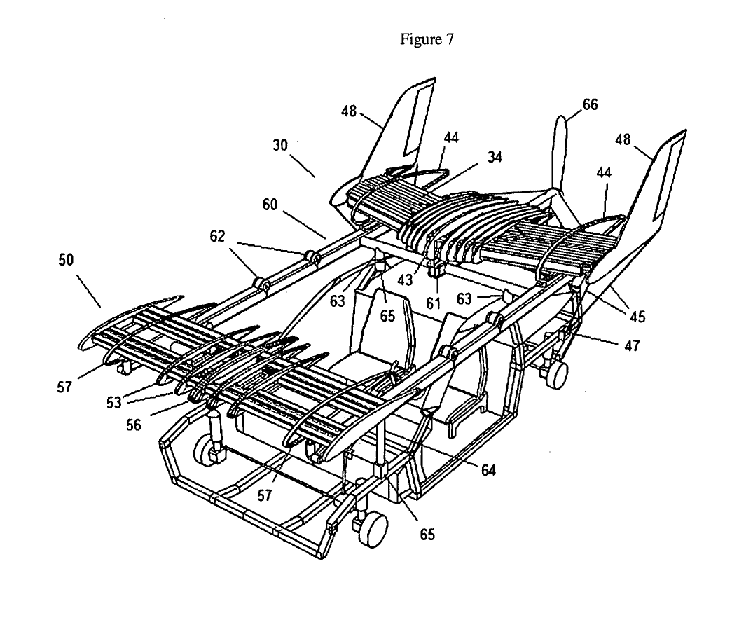

Referring now to the invention as shown in FIGS. 5 to 7, the vehicle is depicted with the wing rack system in transition between flight configuration and driving configuration, with the main wings 30, and canards 50 retracted and the wing rack frame 60 remaining unfolded. The individual sections 31, 32, 33, of the main wings 30 nestle into one another in series to be contained in a relatively smaller volume than the fully extended wings. Outer wing sections 33 slide into the interior of the intermediate wing sections 32, and the intermediate wing sections 32 slide into the interior of each subsequent section in series until all of the outer 33 and intermediate 32 sections are nestled within the inner wing sections 31. This nestling feature allows for the majority of the main wing 30 excluding the vertical stabilizers 48 to fit within the volume of the inner wing sections 31, creating a great reduction in the overall volume of the retracted wings. Likewise, the outer canard sections 52 nestle within the inner canard sections 51 also reducing the span of the canard wings 50.

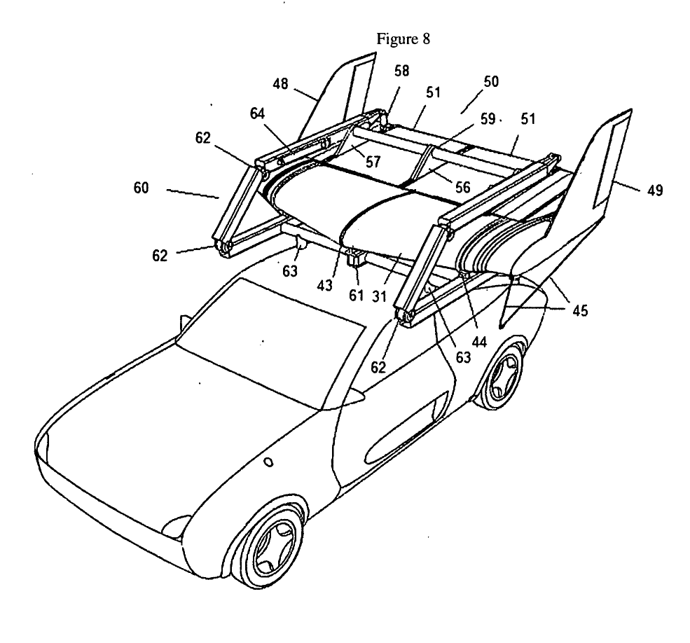

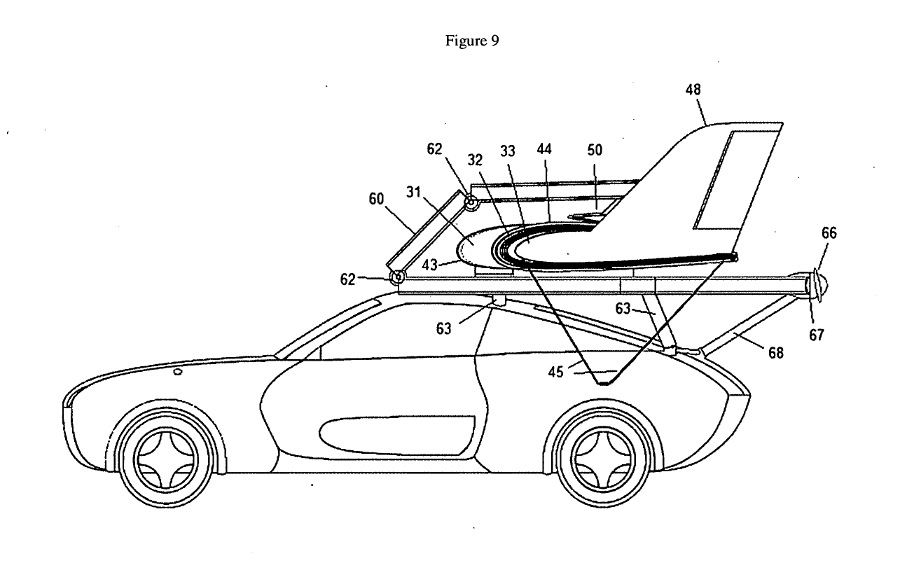

Referring now to the invention as shown in FIGS. 8 and 9, the vehicle is in configuration for driving on roads with the wing rack system still attached. The aft main wings 30 and forward canards 50 are retracted and the forward section of the wing rack frame 60 is folded backwards over the main wings 30. To complete the transition between modes, after the main wings 30, and canards 50 have been fully retracted the forward sections of the wing rack frame 60 fold backward into place above the main wings 30. The design of the frame 60 incorporates articulated hinge joints 62 around which the sections of the wing rack frame 60 may rotate through mechanical actuation. This may include motor or pneumatic or hydraulic actuators built in to the hinges 62 to allow them to be automatically articulated, and mechanisms to secure them in position in both flying and driving configurations, Additionally, the forward frame support struts 64 which connect the forward section of the wing rack frame 60 to the vehicle frame above the front wheels must be disconnected by an automatic mechanical release mechanism, such as an actuated pin or clamp mechanism, before the forward sections of the wing rack frame are folded back. The forward support struts 64 are rotated parallel with the forward section of the wing rack frame 60 when not in flight configuration.

Referring again to the invention as shown in FIGS. 8 and 9, the vehicle is shown with the wing rack system in configuration for driving on roads, with the wing racks system still attached to the vehicle body 10. The retracted main wings 30 fit within the width required to drive on roads, being retracted above the rear wheels behind the passengers, and the retracted forward canards 50 while folded backwards over the main wings 30 fit in between the vertical stabilizers 48 on the ends of the retracted main wings 30. This configuration gives the vehicle added safety on roads and protects the wings 30 and canards 50 while driving, and ensures the forward section of the wing rack frame 60 and canards 50 do not interfere with the driver's vision. The propeller 66 and the propeller hub 67 remain in place at the rear of the wing rack frame 60, and the propeller is turned horizontal to the ground while not needed. These features protect the wings 30, 50 and propeller 66 while in driving configuration and maintains the performance and utility of an automobile.

Referring to the invention as shown in FIGS. 1 to 9, the size of the vehicle in configuration for driving is similar to a traditional automobile, being less than eight feet wide and less than twenty feet long. In configuration for flight, the main wings 30 extend to a wingspan capable of providing the vehicle with the necessary lifting area for flight. The body 10 of the vehicle should be constructed of a lightweight material, such as a carbon fiber composite material, fiberglass, or aluminum to minimize the total weight. The vehicle body 10 and frame 20 should likewise be constructed of a lightweight and high strength material such as graphite, carbon fiber or similar composites, although aluminum or various metallic alloys may be used as well.

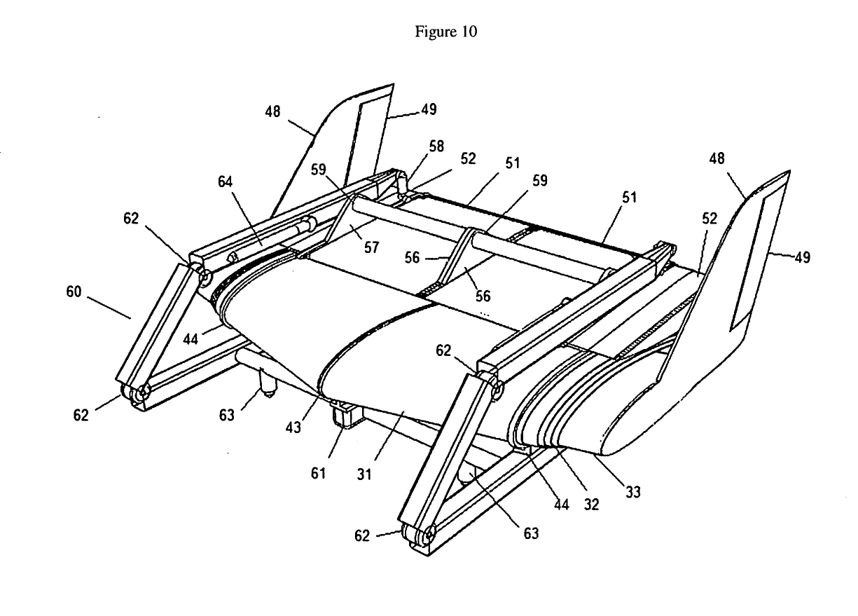

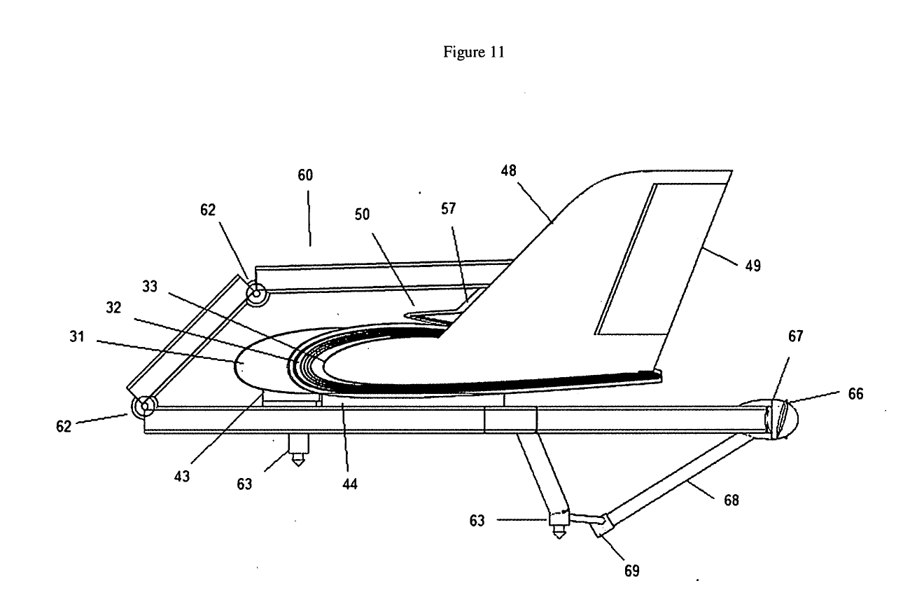

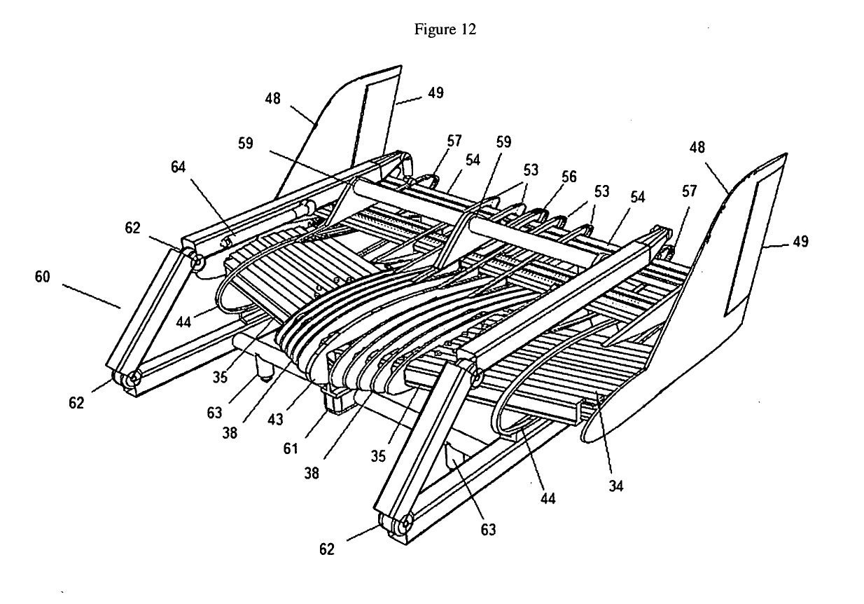

Referring now to the invention as shown in FIGS. 10 to 12, the wing rack system can be removed from the vehicle body 10 entirely for storage. The wing rack frame 60 attaches to the vehicle through several support struts 63, 64, which connect the wing rack frame 60 to the internal frame 20 of the vehicle. The forward support struts 64 automatically disconnect and rotate parallel to the wing rack frame 60 when the forward section of the frame is folded backwards for driving or storage. The rear supports 63 are more permanently fixed, connecting to the vehicle frame 20 by four separate couplings 65, two above the rear wheels and two above the passengers. The rear support struts 63 can be detached from their attachment points manually, so that the wing rack system can be removed from the vehicle when it is not intended to be used for some time. The drive shaft 68 and housing 66 can also be manually disconnected at the attachment point to the vehicle body by a drive shaft coupling 69 at the connection point to the vehicle body 20 so that the wing rack assembly can be removed.

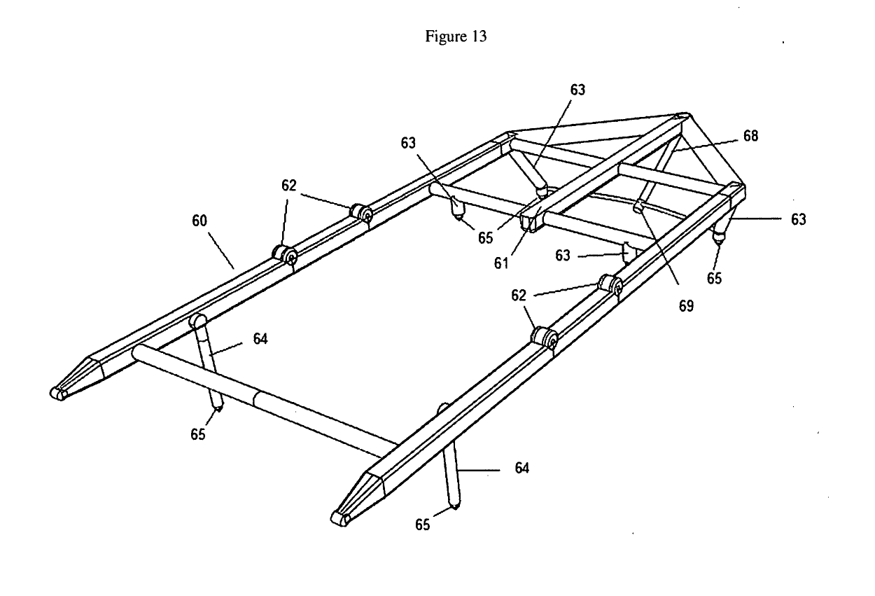

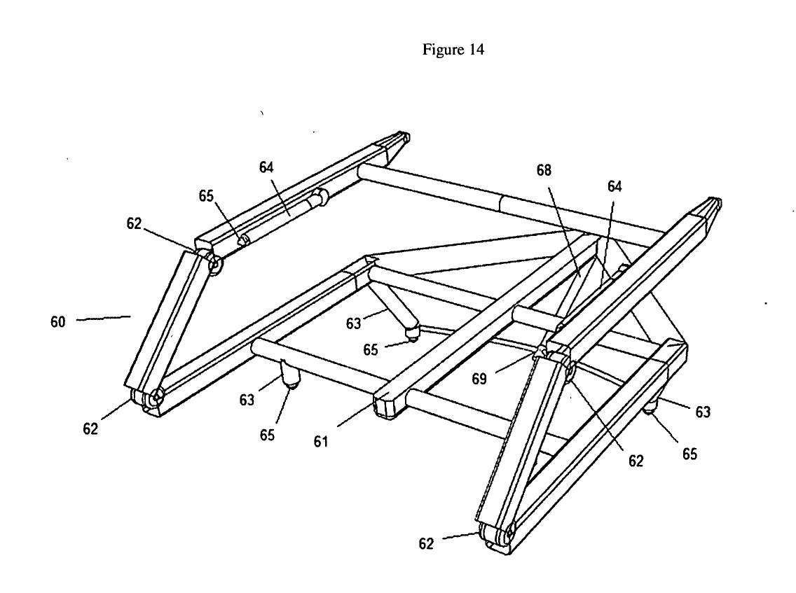

Referring now to the invention as shown in FIGS. 13 and 14, the wing rack frame 60 provides the structure that the main wings 30 and forward canards 50 mount to, to connect them to the vehicle body 10 and internal vehicle frame 20. The wing rack frame 60 is composed of a series of tubes of sufficient strength to suspend the weight of the vehicle plus an appropriate factor of safety while in flight. In the rear center of the wing rack frame 60 is a central wing support beam 61 which the center wing supports 43 attach to, and also which the propeller hub 67 is attached to. This allows the force from the thrust of the propeller 66 to be transmitted directly through the center support beam 61 to the main wings 30. The articulated joints 62 that allow the wing rack frame to fold backwards are designed to have an automatic stop at the angle required for the forward canards 50 to be positioned directly above the main wings 30. The attachment points to the vehicle body interface with the support strut couplings 65 that are likewise designed to carry the load of the weight of the vehicle. The forward support struts 64 rotate at the point of connection to the wing rack frame 60 and are articulated by automatic means. This allows the forward support struts 64 to become parallel to the rest of the wing rack frame 60, to consolidate space when the wing rack frame 60 is in the folded configuration.

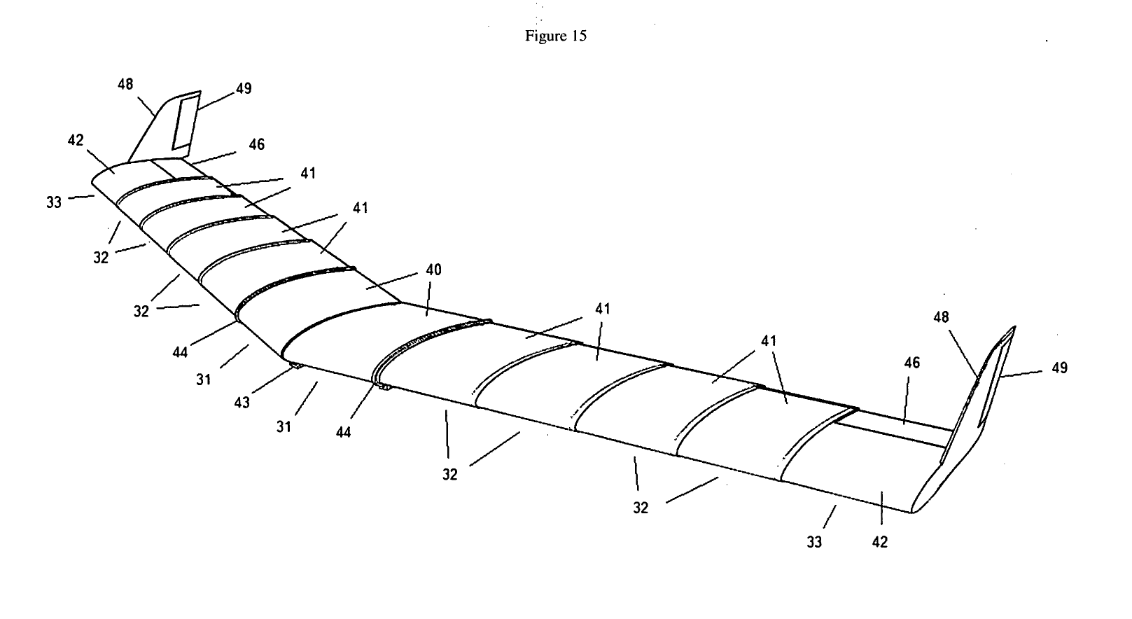

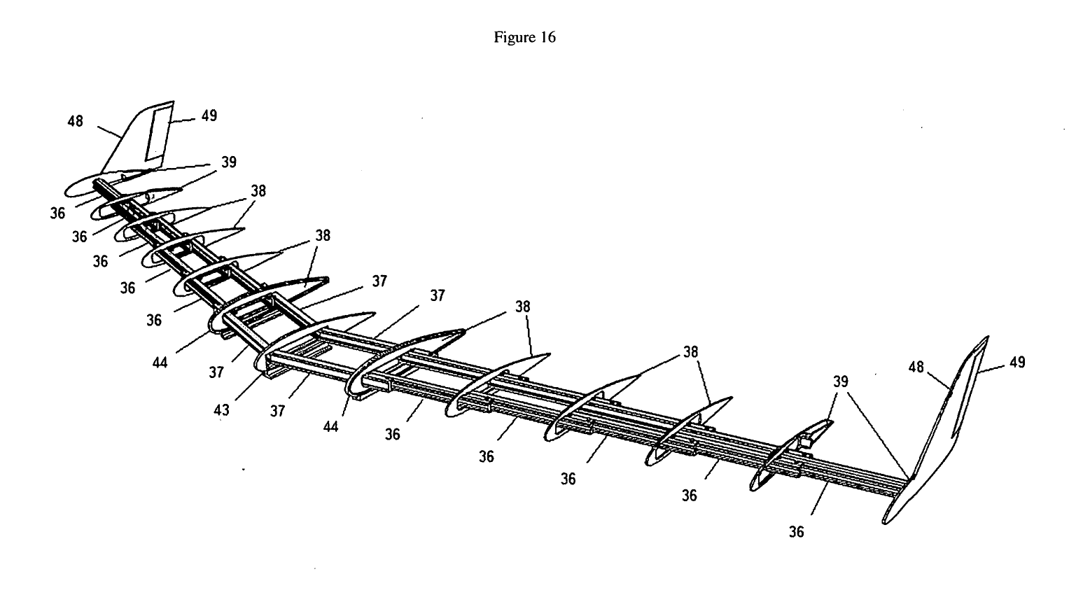

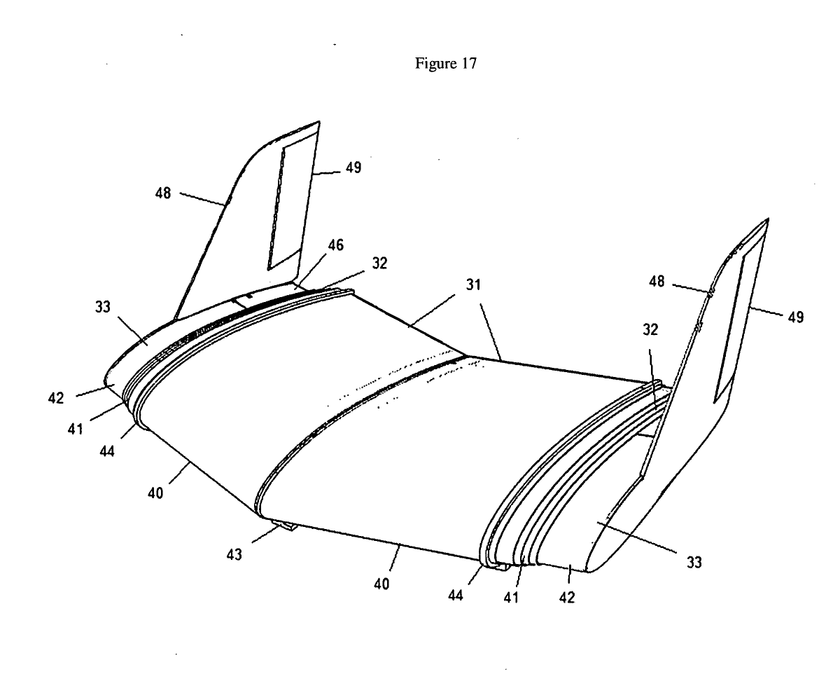

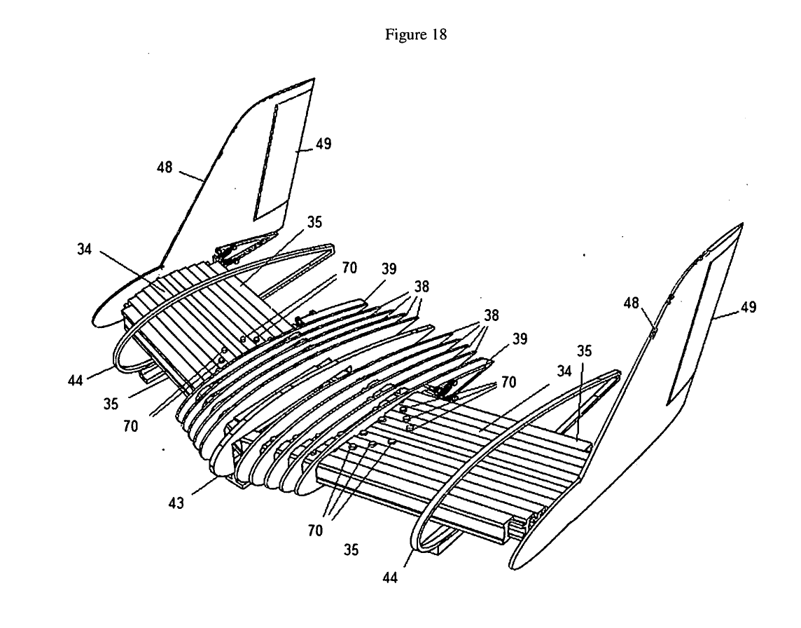

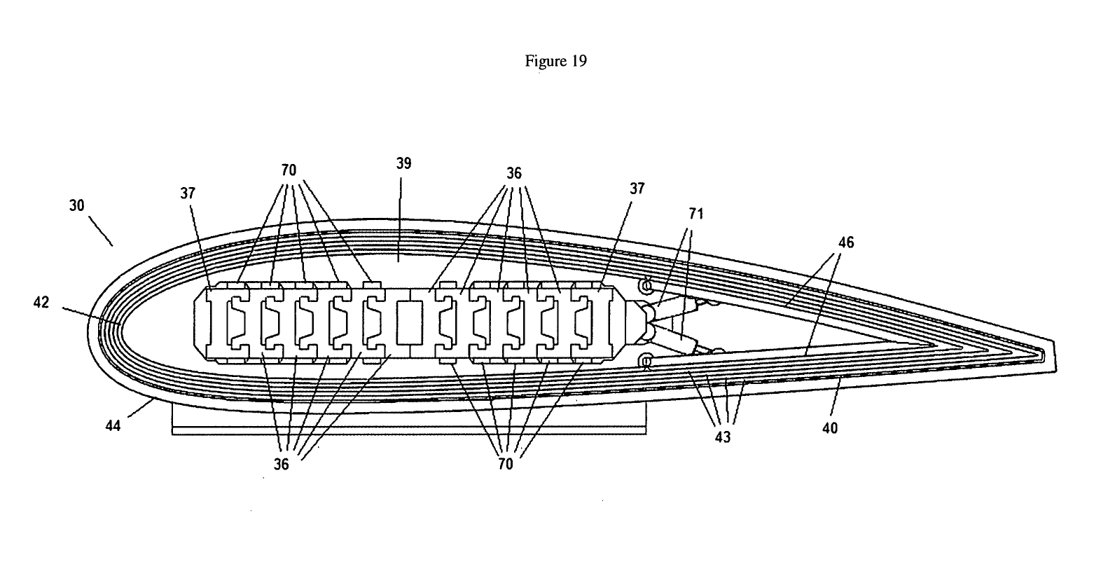

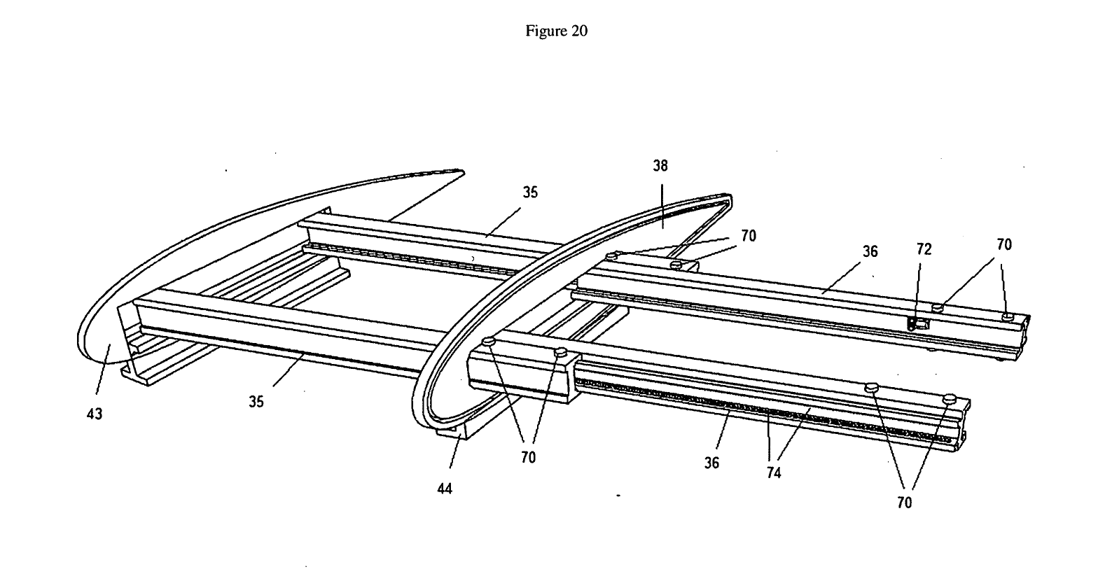

Referring now to the invention as shown in FIGS. 15 to 21, the following description relates to the construction of extendable and retractable telescoping wings. The telescopic main wing 30 is comprised of a plurality of wing sections 31, 32, 33 extending from the inner wing sections 31 with respect to the midline of the wings, through the intermediate wing sections 32 to the outer wing sections 33 at the ends of the wings 30. The inner wing sections 31 are hollow except for the central wing spars 35, and have the greatest cross-sectional area, in order to allow the intermediate wing sections 32 and outer wing sections 33 fit within them when retracted. Intermediate wing sections 32 are also hollow except for the wing spar sections 36. Intermediate wing sections 32 each have a greater cross-sectional area than the sections beyond them in the outward direction to allow those sections to fit within them. The outer wing sections 33 at the ends of the wings 30 do not have any further sections beyond them, and thus only require enough empty space to contain the collapsed wing spar assembly 34 when retracted. The remainder of the space in the outer wing sections 33 can be used to accommodate ailerons 46 and actuators to control them.

Referring in more detail to the invention as shown in FIGS. 15 to 21, the wing sections 31, 32, 33 consist of three primary features: outer wing skin panels 40, 41, 42, which are thin panels with an airfoil cross-sectional shape which provide the lifting surface of the wings; wing ribs 38 on the inward edge of each wing section, which support the wing skin panels 40, 41, 42 and a pair of wing spar sections 35, 36 which also connect to the wing ribs 38 along the inward edge of the wing section 31, 32, 33. Adjacent wing spar sections 35, 36 in adjacent wing sections 31, 32, 33, are interconnected and overlap to form a rigid wing spar assembly 34 that extends the length of the entire wing 30 and provides support for the wing under aerodynamic loads.

Referring still to the invention as shown in FIGS. 15 to 21, the central wing spar sections 35 form a beam across the width of the vehicle and are fixed in place. The central wing spar sections 35 are connected to the center wing support 43 along the centerline of the wings which connects the wing spar assembly 34 to the wing rack frame 60 and supports the weight of the aircraft while in flight. When the wings 30 are extended, the wing ribs 38 and the wing skins 41 in the innermost intermediate wing sections 32 are also supported by the outer wing root support 44 that wraps around the outside of the inner wing sections 31 and also connects to the wing rack frame 60, carrying a portion of the vehicle weight.

Referring now to the invention as shown in FIGS. 15 to 21, the following is a description of how the individual sections are comprised and how they connect to one another. For the inner wing sections 31, the central wing skin panels 40 connect on their inner edge to the central wing support 43. In the intermediate sections 32 the wing skin panels 41 of each section are connected along the inner edge to the wing ribs 38 of each section, which have a similar airfoil shape, and provide the structural support to the wing skin panels 41. The wing ribs 38 contain an empty space large enough to accommodate the collapsed wing spar assembly 34, and are attached to a pair of wing spar sections 36, which fit within the empty space in the wing ribs 38 and connect along the top and bottom edges of the wing spars 36. The remaining wing spar sections 35, 36 in the wing spar assembly 34 fit when retracted into the space within the wing ribs 38. When the wing 30 is extended, the outboard edges of the wing skin panels 40, 41 fit closely within and are supported by the wing rib 38 of the next adjacent outward section 32, 33. The exception to this is the outer wing sections 33, for which the skin is supported on both ends by inner and outer ribs 38 connected to the outermost wing spars 36.

Again referring to the invention as shown in FIGS. 15 to 21, the wing sections 31, 32, 33 are supported internally by the wing spar assembly 34 which is comprised of two wing spar sections 35, 36 per wing section 31, 32, 33 utilizing an interlocking flange design that connects the adjacent wing spar sections 35, 36 into a complete wing spar assembly 34. The wing spar sections 35, 36 are designed with a cross-section in the shape of an I-beam with offset, interlocking flanges. The flanges of the wing spar sections 35, 36 are offset so that they can be situated adjacent to each other and overlap, while maintaining contact between the upper and lower surfaces of the adjacent flanges. In the area that the flanges overlap, corresponding lips on each flange connect the adjacent flanges together by creating a constraint between them in the crosswise direction while allowing adjacent spar sections to slide relative to each other in the lengthwise direction of the beam. The shape of the interlocking cross-sections allow individual wing spar sections 35, 36 to slide with respect to one another in the lengthwise direction of the wing while maintaining structural rigidity and strength in the other perpendicular directions due to the overlap between the lips and flanges of adjacent wing spar sections 35, 36.

Again referring to the invention as shown in FIGS. 15 to 21, The wing spar sections 35, 36 are longer than the wing skin panels 40, 41, 42 of each section and extend beyond the point of connection to next wing section 32 in order for the ends of the adjacent spar sections 35, 36 to overlap and maintain their structural connection while the wings 30 are fully deployed. When the extension of the wing spars 35, 36 reaches the fully extended position, stops on the top and bottom of the wing spar sections, a set distance from the ends of the spars equal to the desired overlap between adjacent spars while extended, contact the wing rib of the next outward section and restrain any further sliding outward. Pneumatically or electrically actuated pins 70 fitted on the upper and lower flanges of the wing spars then extend into corresponding holes in the adjacent wing spar sections 36, connecting the overlapping upper and lower flanges of the adjacent wing spar sections 35, 36, fixing them in relative position to each other and carrying a portion of the stress across the top and bottom of the wing spar assembly 34. In the invention as shown in the figures, the stop that retains the outward sections of the wing is also the housing for the inward wing spar pin 70 on that section of the wing spar. Also, the holes in the wing ribs which accommodate the wing spar assembly 34 are shaped to allow the actuated pin mechanisms 70 and stops of the non-adjacent outward wing spar sections 36 to pass without contact, in order for the whole wing spar assembly 34 to be able to slide freely into its fully retracted or extended state.

The construction details of the invention as shown in FIGS. 15 to 21 include choosing materials for the wing spar sections 35, 36, the wing ribs 38 and the wing skins 40, 41, 42 that have a high strength and low weight, such as extruded carbon fiber rod or other high strength composite material, although metallic materials could be considered as well. The skin panels are to be constructed of lightweight panel material such as carbon fiber, fiberglass, or other composite panels formed on molds. Materials and dimensions of all components shall be determined to meet the requirements of reliability and strength for the aircraft which will utilize the wing.

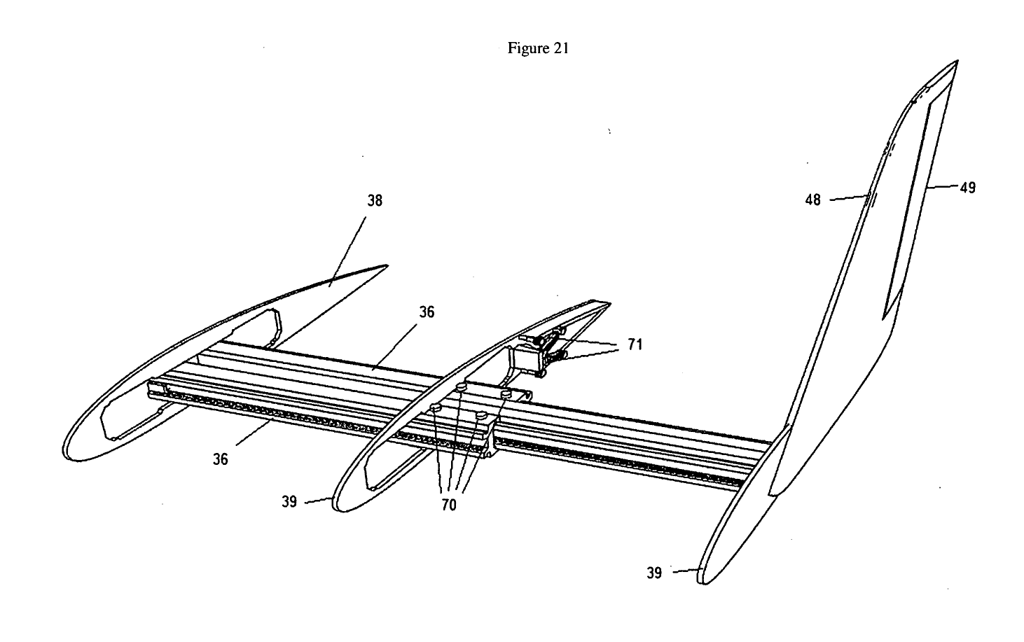

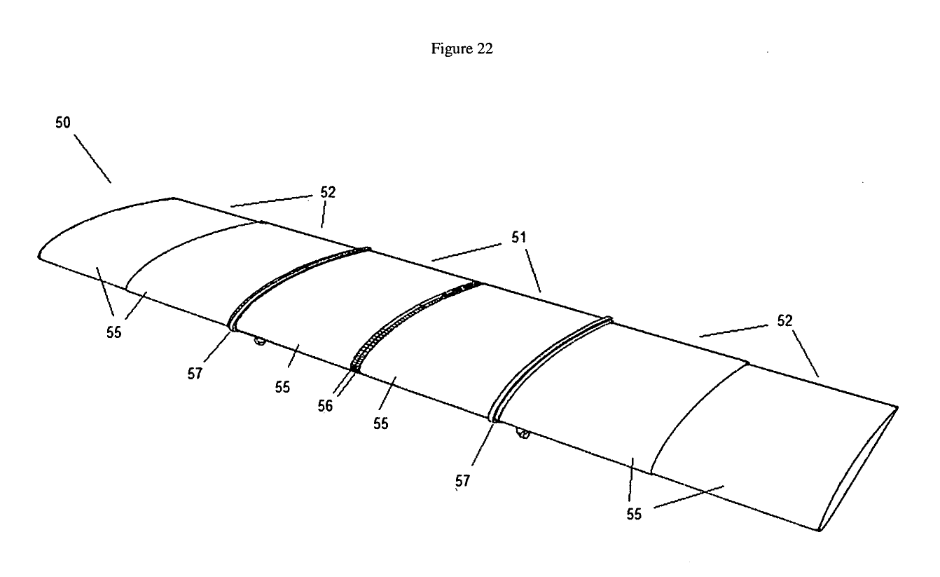

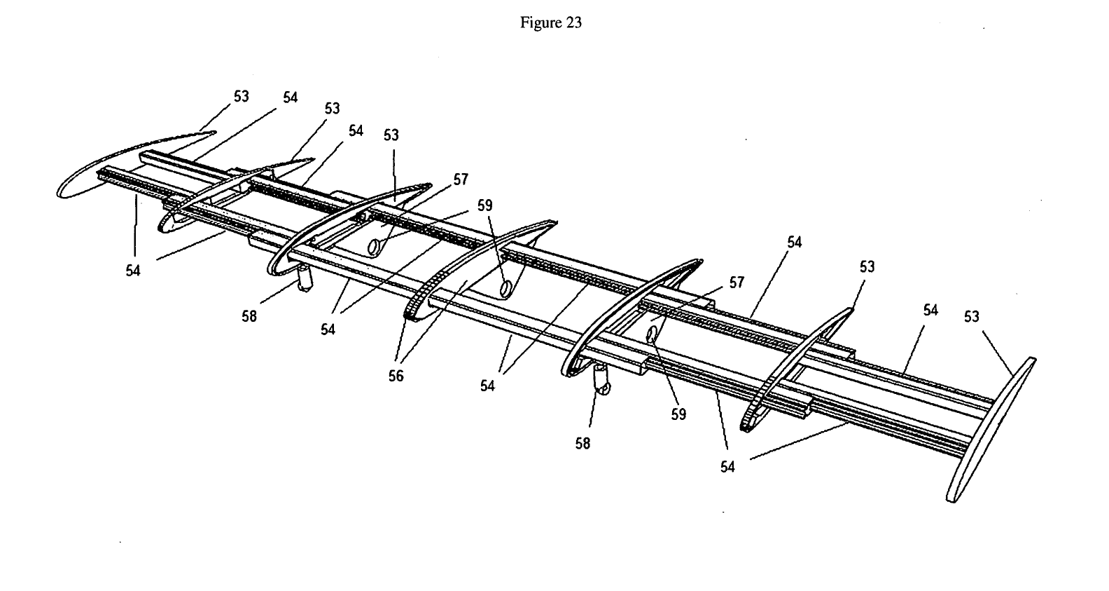

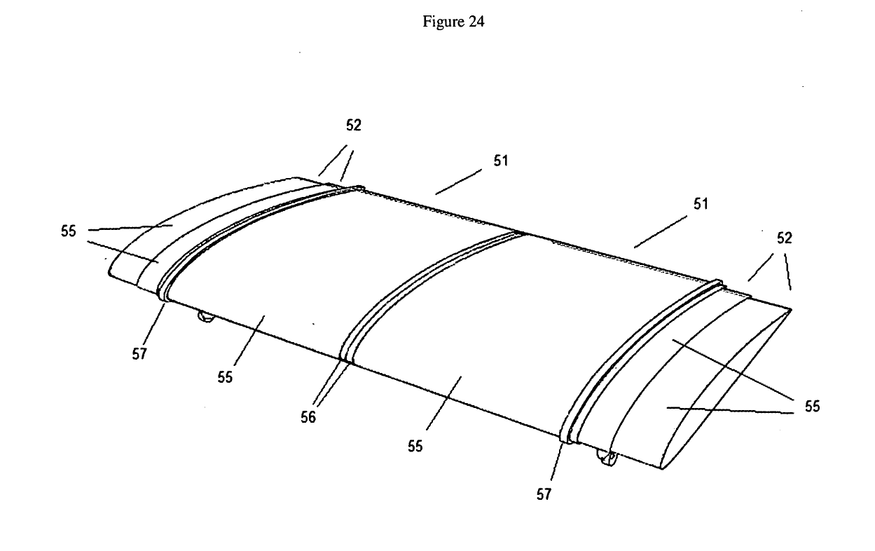

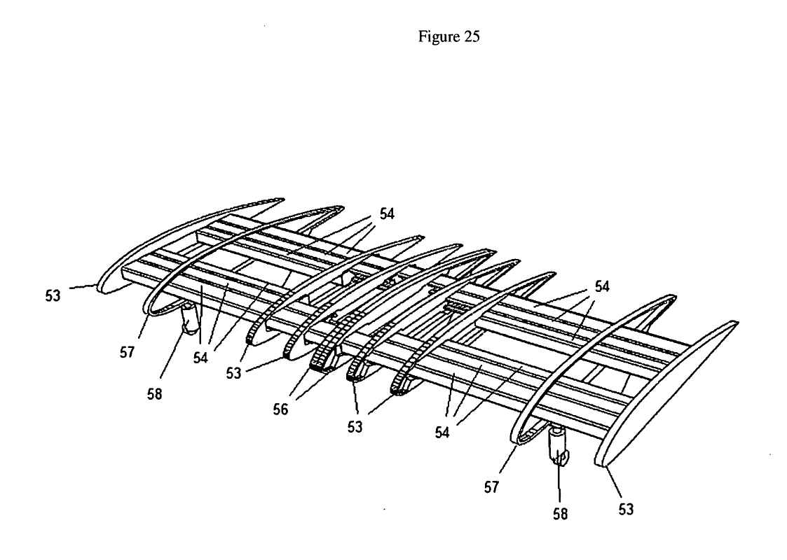

Referring to the invention as shown in FIGS. 21 to 25 the forward canards 50 are constructed in a manner similar to the main wings 30 being comprised of multiple wing sections 51, 52. In the case of the forward canards 50, the inner canard supports 56 and outer canard supports 57 are connected to the wing rack frame 60 through pivoting joints that protrude below the wings themselves. The forward canard wings 50 are also divided in the center, with the canard on each side being fully self-supported by the inner 56 and outer 57 canard wing supports. The inner canard wings sections 51 are comprised of the inner canard support 56, the inner wing canard skin panels 55, the outer canard wing support 57, and the inner canard wing spar sections 54. The inner canard wing sections 51 are of a greater cross sectional area than the outer sections 52, similar to the main wings 30, allowing the outer canard wing sections 52 to slide within the space contained by the wings skin panels 55 of the inner canard wing sections 51. The forward canard wing sections 51, 52 nestle within each other in the same fashion as the main wing sections, 31, 32, 33, but with fewer sections and no need for ailerons or rudders in the outermost sections. The pivoting of the forward canards 50 is controlled by canard actuators 58 which connect the forward section of the outer wing supports 57 to the wing rack frame 60.

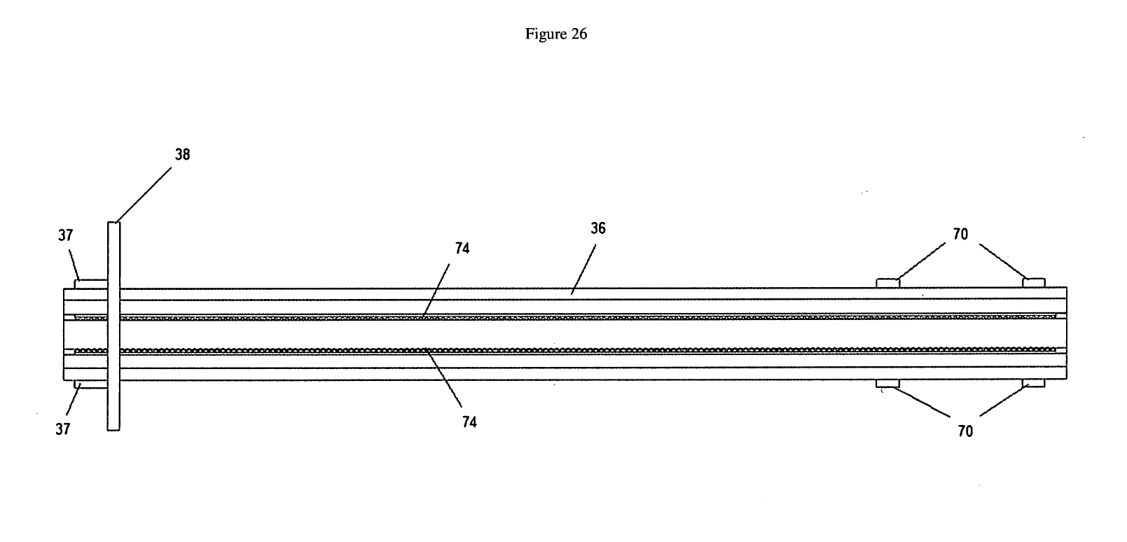

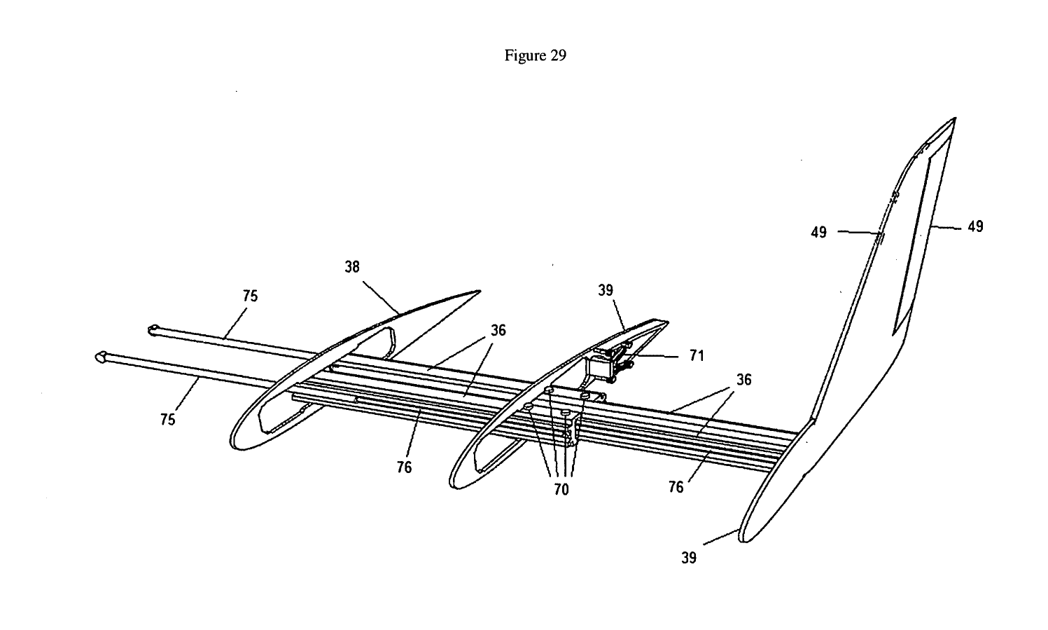

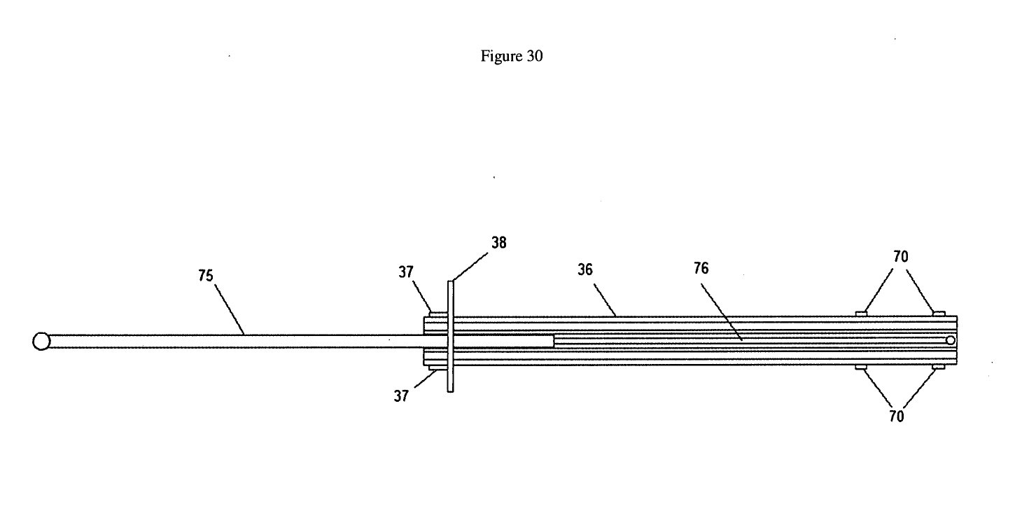

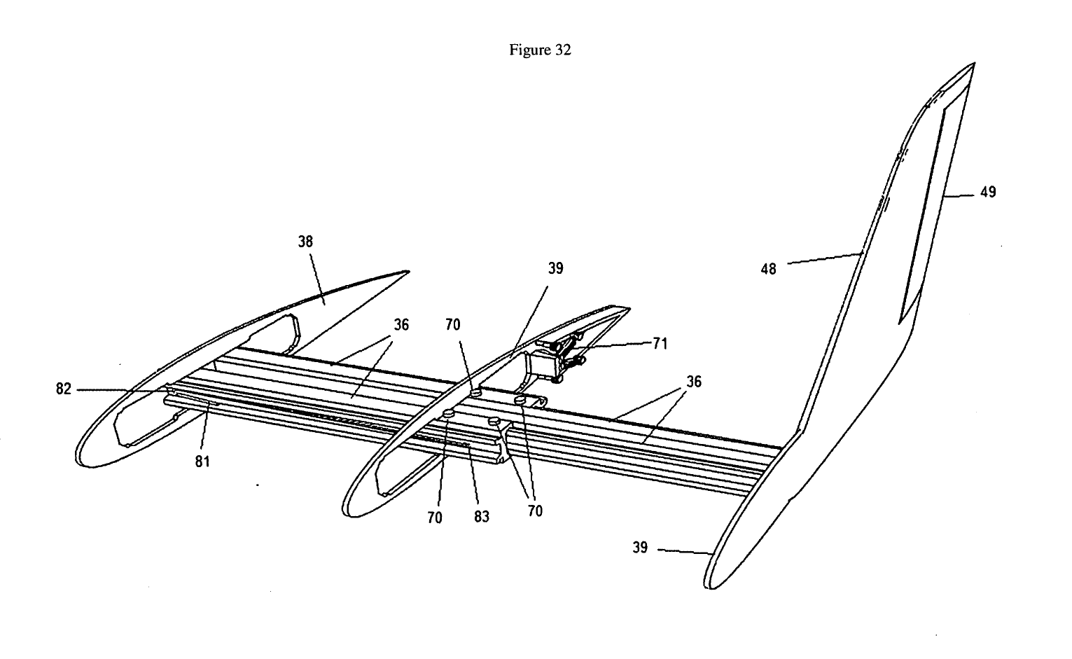

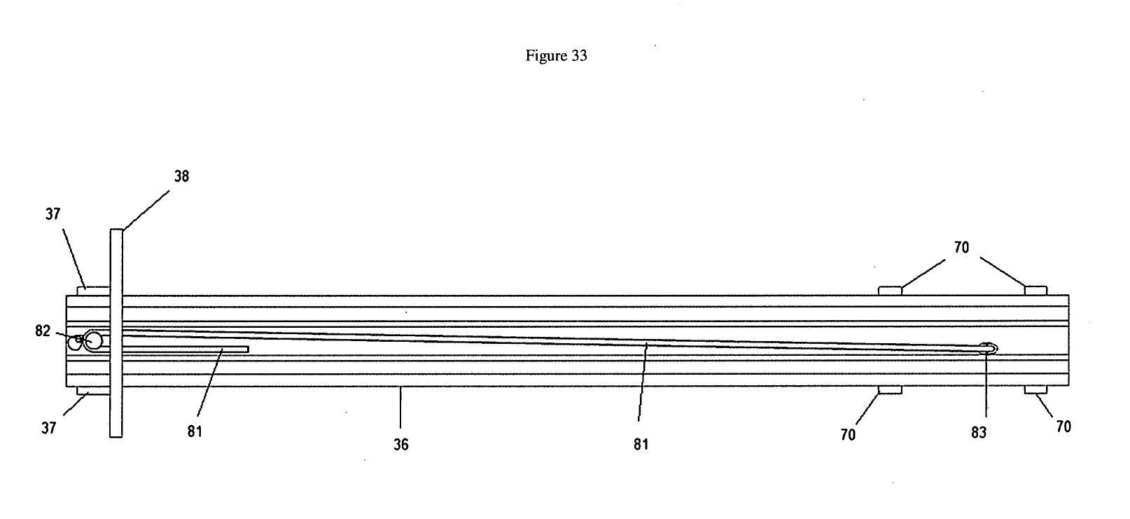

Referring now to the invention as shown in FIGS. 26 to 33, extension and retraction mechanisms are included on each wing spar section 32 in order to extend and retract each set of spars in the wing spar assembly 34, and along with them the wing ribs 38 attached to the wing spar sections 32, 33, and the outer wing skin panels 41, 42 attached to the wing ribs 38, thereby fully extending or retracting the whole wing 30. There are several different possible embodiments of the mechanisms to automatically extend and retract the wing sections, described below.

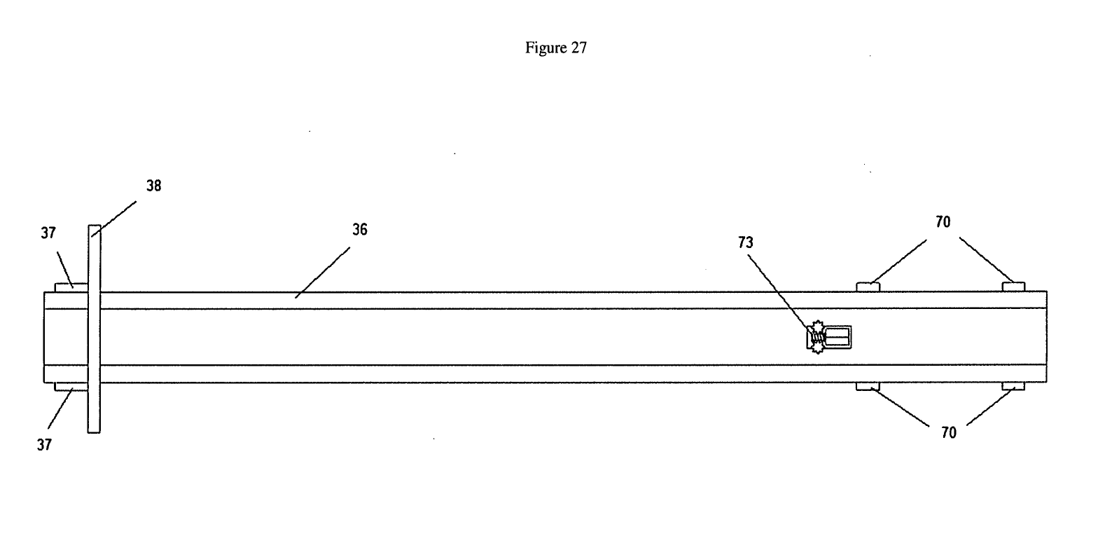

Referring now to the invention shown in FIGS. 26 and 27, in the preferred embodiment of the extension and retraction mechanism, the wings are retracted and extended by geared motor assemblies 71 that are mounted to the interior end of the wing spar sections 36 and comprised of an electric motor 72 and gears 73, with the gear and motor assembly 71 being mounted to the edge of one wing spar section 36 while the teeth of the gears 73 act upon teeth set into the spar flange 74 of the adjacent wing spar section 34, 35. This mechanism allows the electric motor 72 to drive one wing spar section 34 inward or outward with respect to the adjacent wing spar section 34, 35 in the lengthwise direction of the wings 30, depending on the direction of rotation of the motor and the gears.

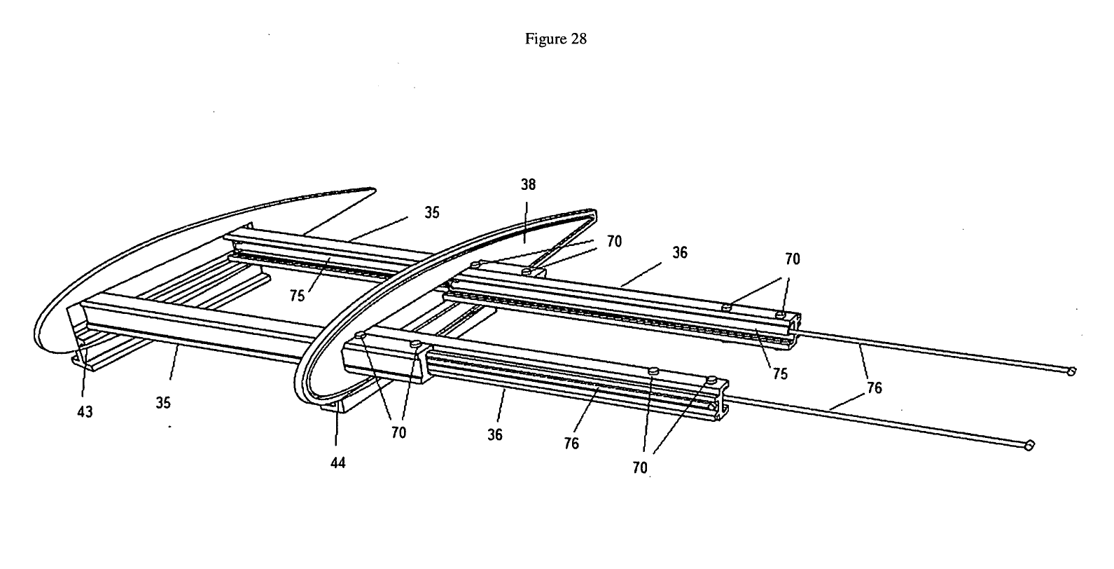

Referring now to the invention shown in FIGS. 28 to 30, in an alternative embodiment of the extension and retraction mechanism, the wings are retracted and extended by pneumatic cylinders 75 that are mounted between the inward end of each wing spar section and the outward end of each adjacent wing spar section. The pneumatic cylinders are comprised of an outer cylinder 75 and an inner piston 76 that extends or retracts under the application of positive or negative pneumatic pressure, supplied by a pneumatic pressure line 79. The base of the outer cylinder 77 is fixed to one end of each wing spar section 34, 35, while the end of each pneumatic piston has an attachment 78 connecting it to the adjacent wing spar section 34 upon which the cylinder 75 acts, extending or retracting the wing sections.

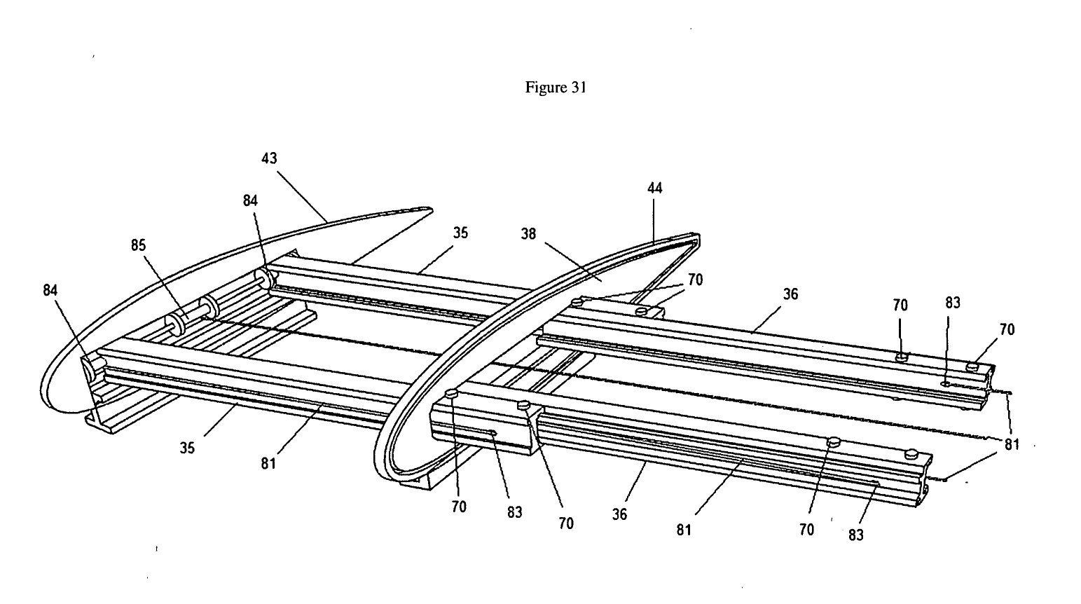

Referring now to the invention shown in FIGS. 31 to 33, in an alternative embodiment of the extension and retraction mechanism, the wings are retracted and extended by a cable 81 which runs between pulleys 80 in the outward end of each wing spar section 34 mounted horizontally in a slot within the wing spar 34 and another pulley 82 mounted vertically at the inward end. The cord is pulled by a winch 83 at the far inward end of the wing 30, pulling the inward and outward ends of adjacent wing spars 34, 35 closer to each other, thus extending the wing sections 31, 32, 33. Retraction is accomplished by pulling the cord 81 attached to the most outward wing section 33 inward.

The advantages of the present invention include, without limitation, providing the user with the ability to travel between destinations more rapidly than a conventional automobile by taking off and landing at local airports, then providing transportation to a final destination on surface roads. Many of the inconveniences of aircraft ownership, such as the requirement to keep the aircraft in storage at a particular runway and find alternate ground transportation on arrival are avoided. Personal freedom in transportation is improved by giving the user an alternative to driving along roads or booking travel through airlines. The user gains the ability to choose a path through the sky, not only reducing transit times but increasing the enjoyment of travel dramatically as well.

In broad embodiment, the present invention is a vehicle capable of driving on roads in a manner common to automobiles and changing form to have the capability to fly in a manner common to single engine aircraft. The invention achieves this goal by using a set of wings comprised of a plurality of telescopic sections supported by internal wing spars which are extended and retracted automatically, and reside upon a foldable frame which is supported above the vehicle body. The wings provide the lift for flight, while a propeller provides the thrust, and on the ground the entire assembly can be stowed for driving in a small volume above the cockpit of the vehicle.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is the following:

1: A wing rack system, comprising: a frame, a plurality of telescoping wings coupled to the frame, the wings being deployable to an extended or retracted position relative to the span of the wings, such that in the extended position the wings are capable of producing lift and in retracted position the volume and span of the wings is reduced, and a propeller attached to the frame, the propeller having an interface for being coupled to an engine to power the propeller, the propeller arranged to provide thrust for the frame.

2: A Wing rack system of claim 1, wherein the wing rack system includes an attachment mechanism for attaching the frame to an automobile or other driving vehicle, the attachment mechanism comprising a plurality of supporting struts that attach the frame to an automobile or other vehicle.

3: A wing rack system of claim 2, wherein the attachment mechanism attaching the wing rack system to an automobile or other driving vehicle may be disconnected and the wing rack system may be detached from the automobile or other driving vehicle.

4: A wing rack system of claim 1, wherein the wing rack frame is divided into a plurality of sections connected by hinges capable of folding the forward sections of the wing rack frame backwards, reducing the total area of the wing rack system.

5: A wing rack system of claim 1, wherein the plurality of telescoping wings are arranged in a ‘canard’ configuration, comprising two sets of telescoping wings of different spans, the set of telescoping wings of the greater span being situated behind the set of telescoping wings of the lesser span.

6: A wing rack system of claim 5 wherein the set of telescoping wings of the lesser span comprise horizontal stabilizers, including mechanical means of adjusting the angle of attack of the wings to control pitch during flight.

7: A wing rack system of claim 5 wherein the set of telescoping wings of the greater span include in the outer-most sections of the telescoping wings ailerons and mechanical means of adjusting the angle of the ailerons to control roll and trim.

8: A wing rack system of claim 5 wherein the set of telescoping wings of the greater span include on the outer ends of the telescoping wings vertical stabilizers with rudder and mechanical means of adjusting the angle of the rudders to control yaw.

9: A Telescoping wing, being deployable to an extended or retracted state, comprising a plurality of individual sections, each section comprising two wing spar sections, a wing rib affixed to the inward edges of said wing spar sections, and a wing skin affixed to said wing rib, wherein each section is constructed such that: wing spar sections of each adjacent wing section include a means of connecting adjacent sections while allowing transverse relative motion in the span-wise direction between adjacent wing spars, wing spar sections of each section being longer in the span-wise dimension than the wing skins, wing ribs of each section affixed on the inward edge of said wing section, being constructed to allow an empty space large enough in dimension to allow wing spar sections of all wing sections to slide within said empty space, and wing skins being constructed such that inward sections along the span of the wing are of a greater overall interior dimension than the outer dimension of the wing skins of adjacent outer sections, allowing said wing skins to nestle within one another.

10: A telescoping wing of claim 9, wherein wing spar sections comprise an extruded length, of a cross sectional shape similar to an I beam, with offset flanges allowing adjacent beam sections to nestle against one another and corresponding lips on the upper and lower surfaces of said flanges, as a means of connecting adjacent sections while allowing transverse relative motion in the span-wise direction between adjacent wing spars.

11: A telescoping wing of claim 9, wherein a telescoping wing is connected to support structures such that the inward-most wing spar and inside edge of the innermost wing section is affixed to a central wing support, and the outer edge of the innermost wing section is affixed to an outer wing support, said supports including means of being mechanically attached to a frame or vehicle.

12: A telescoping wing of claim 9, wherein actuated pins affixed toward the outward ends of wing spar sections upon overlapping flanges extend when the telescoping wings are in fully extended position into corresponding holes within the flanges of adjacent wing spar sections, locking the wing spar sections in a rigid formation and restrained from motion in the lengthwise direction of the beams.

13: A telescoping wing of claim 9, wherein said wings contain means to be extended and retracted automatically, by mechanical means.

14: A telescoping wing of claim 13, wherein said means of automatically extending and retracting said wings comprise a gear and motor assembly attached to each wing spar section which acts upon linear teeth embedded in adjacent wing spar sections

15: A telescoping wing of claim 13, wherein said means of automatically extending and retracting said wings comprise pneumatic or hydraulic pistons connected to the inner and outer ends of adjacent wing spars.

16: A telescoping wing of claim 13, wherein said means of automatically extending and retracting said wings comprise a cable running around a plurality of pulleys at each end of each wing spar section such that pulling on the cables brings the pulleys on the outer end of one wing spar section closer to the pulleys on the inner end of the next outward wing spar, extending the telescoping wings, and a secondary cable connected directly to the outer most wing spar sections, such that pulling said cable retracts the telescoping wings.
